(19) United States
(12) Patent Application Publication
(10) Pub. No.: US 2025/0222695 A1
(43) Pub. Date: Jul. 10, 2025

(54) LIQUID DROPLET EJECTING HEAD

(71) Applicant: BROTHER KOGYO KABUSHIKI KAISHA, Nagoya (JP)

(72) Inventors: Taisuke MIZUNO, Yokkaichi (JP); Michihiro SHIMADU, Toyota (JP); Toru KAKIUCHI, Chita (JP); Yashuhiro SEKIGUCHI, Nagoya (JP); Takaaki YOSHINO, Nagoya (JP)

(21) Appl. No.: 18/975,145

(22) Filed: Dec. 10, 2024

(30) Foreign Application Priority Data
Jan. 5, 2024 (JP) 2024-000754
Jan. 5, 2024 (JP) 2024-000786
Jan. 5, 2024 (JP) 2024-000787
Jan. 5, 2024 (JP) 2024-000788

(51) Int. Cl. B41J 2/14

(52) U.S. Cl. CPC B41J 2/14274; B41J 2002/14306

(57) ABSTRACT

A liquid droplet ejecting head includes: a pressure chamber located along a plane, a nozzle which is open in a direction crossing the plane; a connecting channel connecting the pressure chamber and the nozzle, the connecting channel including a first channel extending parallel to the plane and a second channel extending in a first direction crossing the plane; wherein inertance of the first channel is greater than inertance of the second channel.

### REFERENCE TO RELATED APPLICATIONS

This application claims priorities from Japanese Patent Applications No. 2024-000788 filed on Jan. 5, 2024, No. 2024-000787 filed on Jan. 5, 2024, No. 2024-000786 filed on Jan. 5, 2024, and No. 2024-000754 filed on Jan. 5, 2024. The entire contents of the priority applications are incorporated herein by reference.

### BACKGROUND ART

A liquid droplet ejecting head is known wherein a connecting channel which connects a pressure chamber and a nozzle includes a plurality of portions having mutually different channel cross-sectional areas. The plurality of portions includes a first portion which is adjacent to the pressure chamber and a second portion which is adjacent to the first portion, the first portion being interposed between the pressure chamber and the second portion. The first portion has the smallest channel cross-sectional area among the plurality of portions, and the channel cross-sectional areas, respectively, of the first portion, the second portion, and the pressure chamber satisfy a predetermined condition. This prevents the generation of a satellite droplet, and realizes high-frequency driving.

### SUMMARY

The inventors of the present disclosure have found, as the result of diligent study and research, that providing a portion of which inertance is great in the connecting channel is effective in preventing the satellite droplet. The inertance is inversely proportional to the channel cross-sectional area and proportional to the channel length.

In the above-described known liquid droplet ejecting head, the first portion extends in a direction crossing a plane in which the pressure chamber is located (first direction). The extent to which the channel cross-sectional area of the first portion can be reduced so as to increase the inertance is limited in the manufacturing, and thus such a configuration can be considered wherein the channel length of the first portion is increased. However, in this case, the head becomes large-sized in the first direction.

An object of the present disclosure is to provide a technique contributing to the prevention of satellite droplet and the reduction in the size of the liquid droplet ejecting head in the first direction.

A liquid droplet ejecting head according to an aspect of the present disclosure includes: a pressure chamber located along a plane, a nozzle which is open in a direction crossing the plane; a connecting channel connecting the pressure chamber and the nozzle, the connecting channel including a first channel extending parallel to the plane and a second channel extending in a first direction crossing the plane; wherein inertance of the first channel is greater than inertance of the second channel.

The first channel of which inertance is great is capable of cutting a high-order component of the pressure wave and preventing the satellite droplet. Further, the first channel extends parallel to the plane in which the pressure chamber is located. Therefore, even in a case where the channel length of the first channel is increased to thereby increase the inertance of the first channel, the head is prevented from becoming large-sized in the first direction. In other words, the above-described configuration contributes to both the prevention of satellite droplet and the reduction in the size of the liquid droplet ejecting head in the first direction.

### BRIEF DESCRIPTION OF DRAWINGS

FIG. 1 is a plan view of a printer 100 including a head 1.

FIG. 2 is a block diagram depicting the electrical configuration of the printer 100.

FIG. 3 is a plan view of the head 1.

FIG. 4 is an enlarged view of an area IV in FIG. 3.

FIG. 5 is a cross-sectional view of the head 1 along a V-V line in FIG. 3.

FIG. 6 is a graph indicating the relationship among inertance M1 of a third channel 23, inertance M2 of a first channel 21 and the voltage ratio.

FIG. 7A is a graph indicating the relationship between vibration velocity of meniscus and the time in an area in which voltage ratio exceeds 101%.

FIG. 7B is a graph indicating the relationship between the vibration velocity of meniscus and the time in an area in which voltage ratio is 101% or less.

FIG. 8 is a graph indicating the relationship among the inertance M1 of the third channel 23, the inertance M2 of the first channel 21 and a natural frequency Fr.

FIG. 9 is a graph indicating a drive signal X applied to a piezoelectric element 13X by a driver IC 14.

FIG. 10 is a graph indicating the relationship among the inertance M1 of the third channel 23, the inertance M2 of the first channel 21, and the voltage ratio.

FIG. 11A is a graph indicating the relationship between vibration velocity of meniscus and the time in an area above a curve L1 of FIG. 10.

FIG. 11B is a graph indicating the relationship between the vibration velocity of meniscus and the time in an area below a curve L2 of FIG. 10.

FIG. 11C is a graph indicating the relationship between the vibration velocity of meniscus and the time in an area interposed between the curve L1 and the curve L2 of FIG. 10.

FIG. 12 is a graph indicating a relationship among a width Tm of a main pulse Pm of a driving signal X, a flying velocity and the volume of an ink droplet ejected from the nozzle N12.

FIG. 13 is a diagram of a head 201, corresponding to FIG. 5.

FIG. 14 is a diagram depicting an individual channel 212B of the head 201, corresponding to FIG. 4.

FIG. 15 is a diagram depicting an individual channel 312B of a head, corresponding to FIG. 4.

FIG. 16 is a plan view of a head 401.

FIG. 17 is a cross-sectional view of the head 401 along a XVII-XVII line in FIG. 16.

FIG. 18A is a diagram depicting a case where an ink droplet ejected from a nozzle has a shape which is elongated in an ejection direction, and FIG. 18B is a diagram depicting a case where the ink droplet ejected from the nozzle has a substantially spherical shape.

FIG. 19 is a graph depicting the relationship among a frequency ratio, an amplitude ratio, and a meniscus flowing velocity in a case where a drive frequency is 150 KHz.

FIG. 20 is a graph depicting the relationship among the frequency ratio, the amplitude ratio, and the meniscus flowing velocity in a case where the drive frequency is 200 kHz.

### DESCRIPTION

### First Embodiment

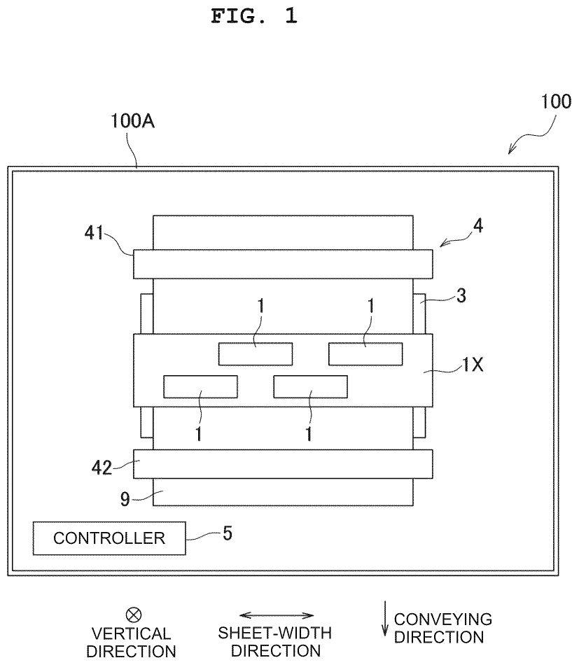

As depicted in FIG. 1, a printer 100 has a head 1 according to the first embodiment of the present disclosure.

The printer 100 includes a casing 100A, a head unit 1X, a platen 3, a conveying mechanism 4, and a controller 5. The head unit 1X, the platen 3, the conveying mechanism 4, and the controller 5 are disposed in the casing 100A. Further, the printer 100 also includes a button disposed in the outer surface of the casing 100A.

The length in a sheet-width direction of the head unit 1X is longer than the length in a conveying direction of the head unit 1X. The sheet-width direction is a direction along the width of a sheet 9 and is orthogonal to the vertical direction. The head unit 1X is fixed to the casing 100A. The type of the head unit 1X is the line system.

The head unit 1X includes four heads 1. The four heads 1 are disposed in a staggered manner in the sheet-width direction. The length in the sheet-width direction of the head 1 is longer than the length in the conveying direction of the head 1.

The platen 3 is a plate along a plane orthogonal to the vertical direction, and is disposed below the head unit 1X. The sheet 9 is supported on the upper surface of the platen 3.

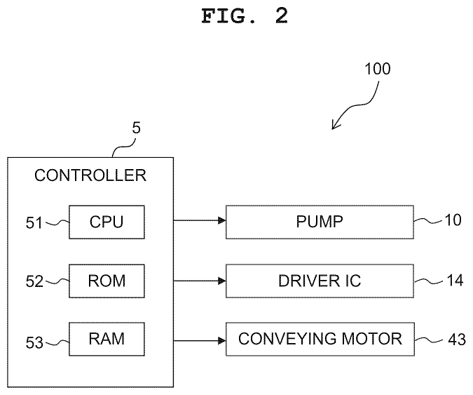

The conveying mechanism 4 includes a roller pair 41 having two rollers, a roller pair 42 having two rollers, and a conveying motor 43 depicted in FIG. 2. In the conveying direction, the head unit 1X and the platen 3 are disposed between the roller pair 41 and the roller pair 42. The conveying direction is orthogonal to the vertical direction and the sheet-width direction.

In a case where the conveying motor 43 is driven by control of the controller 5, the two rollers of each of the roller pairs 41 and 42 rotate. As the rollers of the roller pairs 41 and 42 rotate, the sheet 9 nipped between the rollers of each of the roller pairs 41 and 42 is thereby conveyed in the conveying direction.

As depicted in FIG. 2, the controller 5 includes a CPU 51, a ROM 52, and a RAM 53.

The CPU 51 executes various kinds of control in accordance with a program and/or data stored in the ROM 52 and/or RAM 53, based on data input from an external apparatus. The external apparatus is, for example, a personal computer (PC).

The ROM 52 stores the program and/or the data with which the CPU 51 performs various kinds of control. The RAM 53 temporarily stores data to be used in a case where the CPU 51 executes the program.

Next, the configuration of the head 1 will be described.

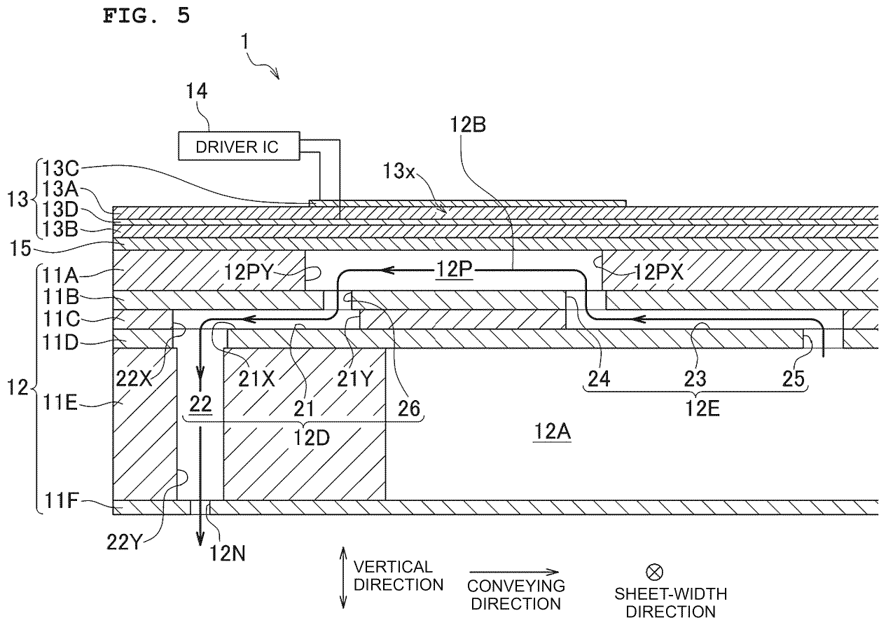

As depicted in FIG. 5, the head 1 includes a channel member 12, an actuator member 13, and a sealing member 15 disposed between the channel member 12 and the actuator member 13.

The channel member 12 has six plates 11A to 11F. The plates 11A to 11F are stacked in the vertical direction and adhered to one another. The plates 11A to 11F have holes formed therein and constructing a channel. The channel includes a common channel 12A and a plurality of individual channels 12B.

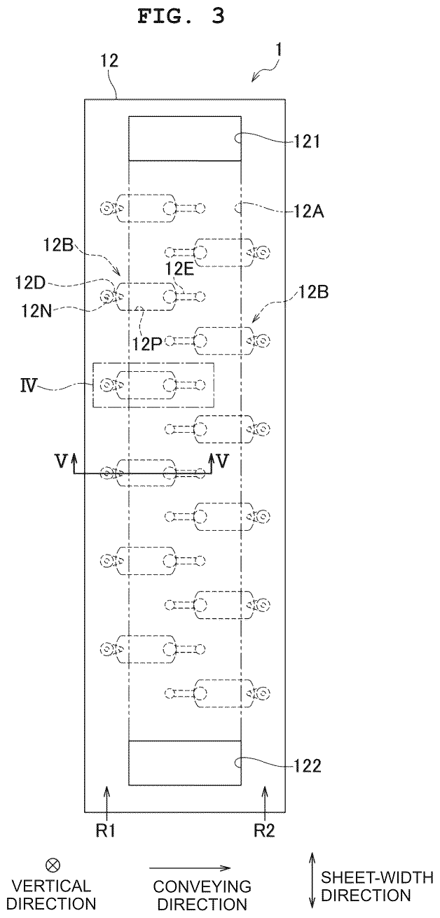

As depicted in FIG. 3, the common channel 12A extends in the sheet-width direction. A supply port 121 is connected to one end in the sheet-width direction of the common channel 12A. A return port 122 is connected to the other end in the sheet-width direction of the common channel 12A. The supply port 121 and the return port 122 are open in the upper surface of the channel member 12. The upper surface of the channel member 12 is the upper surface of the plate 11A which is the uppermost layer among the six plates 11A to 11F. The supply port 121 and the return port 122 communicate with an ink tank via a tube. The common channel 12A communicates with the ink tank via the supply port 121 and the return port 122, and communicates with the plurality of individual channels 12B.

As depicted in FIG. 3, the plurality of individual channels 12B are located in a staggered manner in the sheet-width direction. Each of the plurality of individual channels 12B includes a pressure chamber 12P, a nozzle 12N, a connecting channel 12D which connects the pressure chamber 12P and the nozzle 12N, and a communicating channel 12E which communicates the pressure chamber 12P and the common channel 12A with each other. Nozzles 12N, each of which is included in a corresponding individual channel 12B of the plurality of individual channels 12B, are located in a staggered manner in the sheet-width direction, constructing two nozzle rows R1 and R2. The nozzle row R1 is constructed of nozzles 12 aligned in the sheet-width direction. The nozzle row R2 is constructed of nozzles 12N aligned in the sheet-width direction.

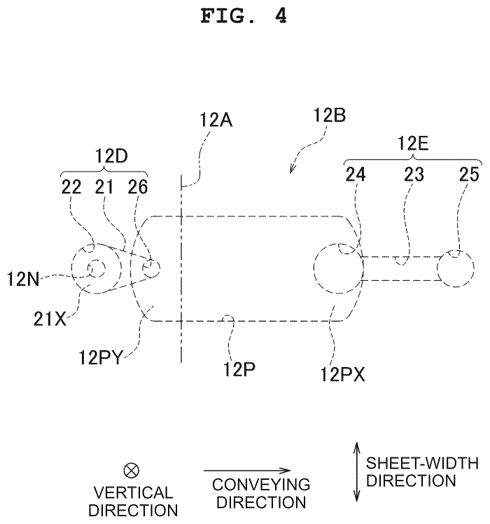

As depicted in FIG. 4, the pressure chamber 12P is located along the plane orthogonal to the vertical direction. The length in the conveying direction of the pressure chamber 12P is longer than the length in the sheet-width direction of the pressure chamber 12P. The pressure chamber 12P has one end 12PX which is a downstream end thereof in the conveying direction, and the other end 12PY which is an upstream end thereof in the conveying direction. The one end 12PX and the other end 12PY are located in a central portion in the sheet-width direction of the pressure chamber 12P.

In the present embodiment, a plane in which the pressure chamber 12P is located is the plane orthogonal to the vertical direction, and corresponds to a “plane” of the present disclosure. The vertical direction is a direction crossing the plane in which the pressure chamber 12P is located, and corresponds to a “first direction” of the present disclosure. A direction along the conveying direction, i.e., the left-right direction along the sheet surface of FIG. 4, is a direction passing through the one end 12PX and the other end 12PY of the pressure chamber 12P, and corresponds to a “second direction” of the present disclosure. The sheet-width direction is a direction orthogonal to the conveying direction and along the above-described plane, and corresponds to a “third direction” of the present disclosure.

As depicted in FIG. 5, the pressure chamber 12P is defined by a hole formed in the plate 11A and is open in the upper surface of the channel member 12.

As depicted in FIGS. 4 and 5, the connecting channel 12D connects the nozzle 12N and the other end 12PY of the pressure chamber 12P, and has a first channel 21, a second channel 22, and a vertical hole 26.

As depicted in FIG. 5, the second channel 22 is defined by a hole formed in the plate 11E and extends in the vertical direction. The second channel 22 has one end 22X in the vertical direction and the other end 22Y in the vertical direction. The other end 22Y of the second channel 22 is connected to the nozzle 12N. Each of the second channel 22 and the nozzle 12N has a columnar shape. The diameter of the second channel 22 is greater than the diameter of the nozzle 12N.

As depicted in FIG. 5, the first channel 21 extends in the conveying direction and is parallel to the plane in which the pressure chamber 12P is located. The first channel 21 has one end 21X which is an upstream end thereof in the conveying direction, and the other end 21Y which is a downstream end thereof in the conveying direction. The one end 21X is connected to the one end 22X of the second channel 22. The other end 21Y is connected to the pressure chamber 12P via the vertical hole 26.

As depicted in FIG. 5, the vertical hole 26 is formed in the plate 11B, and extends downward from the other end 12PY of the pressure chamber 12P. The first channel 21 is defined by a hole formed in the plate 11C.

As depicted in FIG. 4, the channel width of the first channel 21 decreases from the upstream toward the downstream in the conveying direction. In the first channel 21, the channel width is the length in the sheet-width direction. The channel width of the downstream end in the conveying direction of the first channel 21 is the same as the diameter of the vertical hole 26. The channel cross-sectional area of the vertical hole 26 is smaller than the channel cross-sectional area of the one end 21X of the first channel 21.

Here, the inertance of the first channel 21 is greater than the inertance of the second channel 22. In other words, the head 1 of the present embodiment has such a configuration that the first channel 21 of which inertance is great is located in the connecting channel 12D, and thus is effective in preventing the satellite droplet. The inertance of a channel is expressed as ρL/S [kg/m⁴] in a case where the cross-sectional area of the channel is S [m²], the length of the channel is L [m], and the density of the ink in the channel is p [kg/m³].

Note that the inertance of the first channel 21 is 1.20×10⁷ [kg/m⁴] or more, and is equal to or less than the inertance of the nozzle 12N.

As depicted in FIGS. 4 and 5, the communicating channel 12E communicates one end 12PX of the pressure chamber 12P and the common channel 12A with each other. The communicating channel 12E has a vertical hole 24 which communicates with the one end 12PX of the pressure chamber 12P, a vertical hole 25 which communicates with the common channel 12A, and a third channel 23 which extends in the conveying direction between the vertical holes 24 and 25.

As depicted in FIG. 5, the vertical hole 24 is formed in the plate 11B and extends downward from the one end 12PX of the pressure chamber 12P. The vertical hole 25 is formed in the plate 11D and extends upward from the common channel 12A. The third channel 23 is defined by a hole formed in the plate 11C.

The channel width of the third channel 23 is constant in the conveying direction and is smaller than the diameter of the vertical hole 24 and the diameter of the vertical hole 25. In the third channel 23, the channel width is a length in the sheet-width direction.

As depicted in FIG. 5, the nozzle 12N is defined by a hole formed in the plate 11F and is open in the lower surface of the plate 11F. The lower surface of the plate 11F is the lower surface of the channel member 12. The nozzle 12N is open downward, i.e., in the direction crossing the plane in which the pressure chamber 12P is located.

In the individual channel 12B, the vertical holes 24 to 26, the second channel 22, and the nozzle 12N extend in the vertical direction.

The ink in the ink tank is supplied to the common channel 12A via the supply port 121 by driving of the pump 10 depicted in FIG. 2 under the control of the controller 5, and the ink is distributed from the common channel 12A to the plurality of individual channels 12B.

In a case where the volume of the pressure chamber 12P decreases by driving of the piezoelectric element 13X which will be described later, pressure is applied to the ink in the pressure chamber 12P. The ink to which pressure is applied passes through the connecting channel 12D and is ejected as an ink droplet from the nozzle 12N.

The ink which is supplied to the common channel 12A via the supply port 121 but is not distributed to the individual channel 12B returns to the ink tank via the return port 122.

As depicted in FIG. 5, the sealing member 15 is disposed in the upper surface of the channel member 12 so as to cover the plurality of pressure chambers 12P. The sealing member 15 is made of a material having low permeability with respect to the ink, such as stainless steel, etc.

As depicted in FIG. 5, the actuator member 13 is fixed to the upper surface of the channel member 12 via the sealing member 15. The actuator member 13 includes piezoelectric layers 13A and 13B, a plurality of individual electrodes 13C, and a common electrode 13D. The piezoelectric layers 13A and 13B and the common electrode 13D are disposed to cover the plurality of pressure chambers 12P. Each of the plurality of individual electrodes 13C is provided with respect to a corresponding pressure chamber 12P of the plurality of pressure chambers 12P, and is disposed to overlap with the corresponding pressure chamber 12P in the vertical direction.

In the actuator member 13, portions each of which overlaps with a corresponding pressure chamber 12P of the plurality of pressure chambers 12P in the vertical direction function as a plurality of piezoelectric elements 13X. Each of the plurality of piezoelectric elements 13X can be deformed independently according to the potential applied to each of the plurality of individual electrodes 13C. Each of the piezoelectric elements 13X is not a thin film piezoelectric element but a bulk acoustic wave (BAW) microwave filter. The thin film piezoelectric element is a micro device in which piezoelectric elements are integrated by sequentially depositing thin films such as an electrode film, a piezoelectric film, etc., on a substrate, namely, so-called micro electro mechanical systems (MEMS). The bulk acoustic wave microwave filter is a piezoelectric element in which piezoelectric sheets obtained by being calcinated are stacked.

The plurality of individual electrodes 13C and the common electrode 13D are electrically connected to a driver IC 14. The driver IC 14 maintains the potential of the common electrode 13D at the ground potential, whereas the driver IC 14 changes the potential of each of the plurality of individual electrodes 13C. The common electrode 13D functions as a common electrode which is common to the plurality of piezoelectric elements 13X.

The driver IC 14 generates a drive signal based on a control signal from the controller 5, and supplies the drive signal to each of the plurality of individual electrodes 13C. The drive signal changes the potential of each of the plurality of individual electrodes 13C between a predetermined driving potential and the ground potential.

As described above, according to the present embodiment, the high-order component of the pressure wave can be cut by the first channel 21 (see FIG. 5) having the great inertance, and the satellite droplet can be prevented. Further, the first channel 21 extends parallel to the plane in which the pressure chamber 12P is located. Therefore, even in a case where the channel length of the first channel 21 is increased to thereby increase the inertance of the first channel 21, the head 1 does not become large-sized in the vertical direction. In the present embodiment, the channel length of the first channel 21 is along the conveying direction. Thus, according to the present embodiment, both the prevention of satellite droplet and the reduction in the size of the head 1 in the vertical direction can be achieved at the same time.

The first channel 21 has the other end 21Y connected to the pressure chamber 12P (see FIG. 5). In this case, the first channel 21 of which inertance is great is located closer to the pressure chamber 12P than the second channel 22 is, and thus the high-order component of the pressure wave can be efficiently cut and the satellite droplet can be prevented more reliably.

The inertance of the first channel 21 is equal to or less than the inertance of the nozzle 12N (see FIG. 5). In a case where the inertance of the first channel 21 is greater than the inertance of the nozzle 12N, the pressure wave is likely to be reflected in the first channel 21 of which the inertance is great, leading to a necessity for increasing the drive voltage applied to the piezoelectric element 13X in order to propagate the pressure wave up to the nozzle 12N. In this regard, in the head 1 according to the present embodiment, the inertance of the first channel 21 is equal to or less than the inertance of the nozzle 12N, and thus the pressure wave is unlikely to be reflected in the first channel 21, and the drive voltage applied to the piezoelectric element 13X can be made low.

The head 1 includes the plates 11B to 11E which construct the connecting channel 12D (see FIG. 5). In this configuration, in a case where a first portion with a locally small channel cross-sectional area is provided as in the known liquid droplet ejecting head as described above, an adhesive by which the plates 11B to 11F are adhered to one another might enter the first portion and block the first portion. In contrast, in the present embodiment, the first channel 21 extends parallel to the plane in which the pressure chamber 12P is located, and thus the channel length can be made long while the channel cross-sectional area can be made of such an extent that prevents the first channel 21 from being blocked by the adhesive. In other words, the blockage of the channel by the adhesive can be prevented.

Both the first channel 21 and the third channel 23 are located in the plate 11C which is one of the plates 11B to 11E (see FIG. 5). In this case, the first channel 21 and the third channel 23 can be formed in the same step, and thus the dimensional variation in each of the first channel 21 and the third channel 23 is reduced, establishing the relationship between the inertance of the first channel 21 and the inertance of the third channel 23 as described above. In contrast, in a case where the first channel 21 and the third channel 23 are located in separate plates, the first channel 21 and the third channel 23 are formed in separate steps. In this case, the overlap of dimensional variations occurring in the respective steps might prevent the relationship between the inertance of the first channel 21 and the inertance of the third channel 23 as described above from being established, in some cases.

The first channel 21 and the third channel 23 are located over the entire thickness of the plate 11C (see FIG. 5). In this case, the length in the vertical direction of each of the first channel 21 and the third channel 23 can be made constant, as compared to a case where the first channel 21 and the third channel 23 are located in a portion of the thickness of the plate 11C by half etching, etc. Further, the size of each of the first channel 21 and the third channel 23 can be made as designed.

The one end 12PX and the other end 12PY in the conveying direction of the pressure chamber 12P are located in the central portion in the sheet-width direction of the pressure chamber 12P (see FIG. 4). In a case where the one end 12PX and the other end 12PY are located, respectively, at the one end and the other end in the sheet-width direction of the pressure chamber 12P, the propagation distance of the pressure wave in the pressure chamber 12P is long and the natural frequency Fr is low. In contrast, in the above-described configuration, the propagation distance is short and the natural frequency Fr is high. As a result, the driving frequency can be increased.

The inertance of the first channel 21 is 1.20×107 [kg/m⁴] or more. With this, the high-order component of the pressure wave can be cut and the satellite droplet can be prevented.

Next, the analysis performed by the inventors of the present disclosure will be described.

The inventors of the present disclosure have focused on the fact that the inertance of the third channel 23 and the inertance of the first channel 21 affects the drive voltage applied to the piezoelectric element 13X and the natural frequency Fr of the individual channel 12B, and have performed an analysis so as to obtain such a relationship between the inertance of the third channel 23 and the inertance of the first channel 21 that can reduce the drive voltage applied to the piezoelectric element 13X at the high drive frequency.

The inertance of a channel is expressed as ρL/S [kg/m⁴] in a case where S [m²] is the cross-sectional area of the channel, L [m] is the length of the channel, and p [kg/m³] is the density of the ink in the channel.

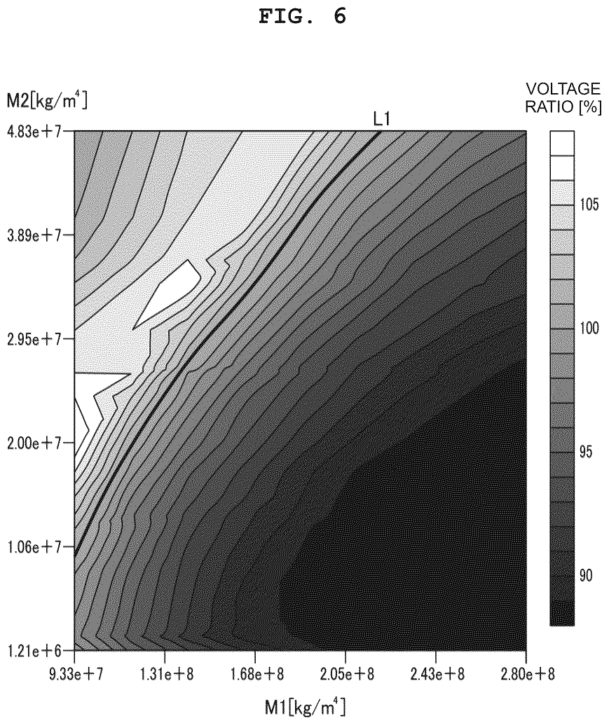

FIGS. 6 to 8 indicate the results of the analysis performed by the inventors of the present disclosure.

As appreciated from FIG. 6, a correlation is present among inertance M1 of the third channel 23, inertance M2 of the first channel 21, and the voltage ratio. The voltage ratio is a ratio obtained by setting the drive voltage to “1” in a case where the viscosity of the ink in the channel is 7 cps, the tension of the ink is 24 mN/m, the configuration other than the communicating channel 12E and the second channel 22 in the individual channel 12B is a predetermined configuration, and the flying velocity of the ink droplet ejected from the nozzle 12N becomes a predetermined velocity (for example, 7 m/s).

In FIG. 6, a curve L1 is a line along a voltage ratio of 101%, and can be approximated by an expression “M2=3.23×10⁻¹×M1−1.95×10⁷ (wherein M1 is the inertance [kg/m⁴] of the third channel 23, and M2 is the inertance [kg/m⁴] of the first channel 21). The drive voltage for the voltage ratio of 101% is, for example, 21V.

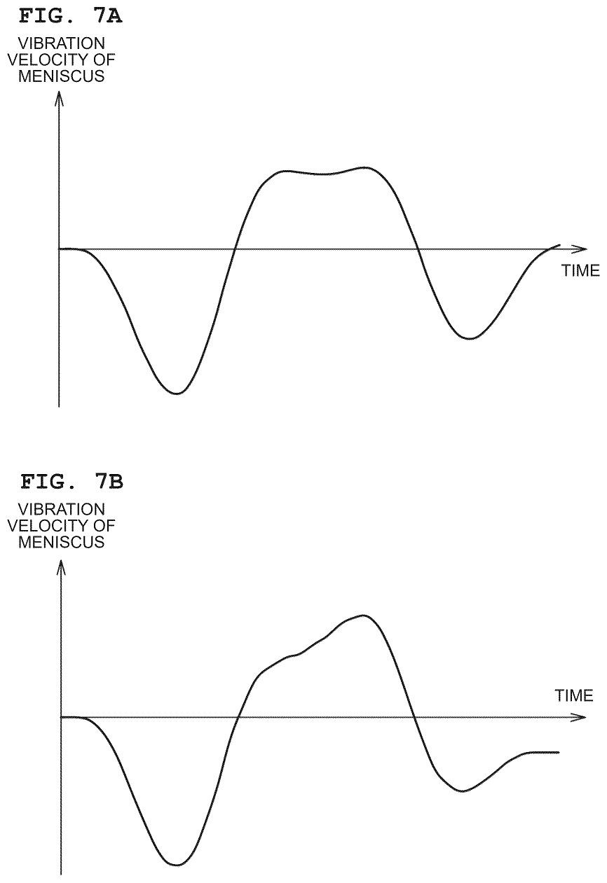

An area above the curve L1 is an area in which the voltage ratio exceeds 101%. In this area, as depicted in FIG. 7A, the vibration velocity of the meniscus formed in the nozzle 12N changes gradually. Therefore, the ink droplet cannot be ejected from the nozzle 12N easily at a low drive voltage.

The curve L1 and an area below the curve L1 are areas in each of which the voltage ratio is 101% or less. In these areas, as depicted in FIG. 7B, the vibration velocity of the meniscus formed in the nozzle 12N changes steeply. Therefore, the ink droplet can be ejected from the nozzle 12N easily even at a low drive voltage.

In this regard, the head 1 of the present embodiment satisfies the following expression (1). That is, by allowing the voltage ratio to be in the curve L1 and the area below the curve L1 in FIG. 6, the vibration velocity of the meniscus changes steeply, even in a case where the drive voltage applied to the piezoelectric element 13X is low, thereby allowing the ink droplet to be ejected from the nozzle 12N.

$$M 2 \leq 3.23 \times {10}^{- 1} \times M 1 - 1.95 \times {10}^{7} \qquad Expression ( 1 )$$

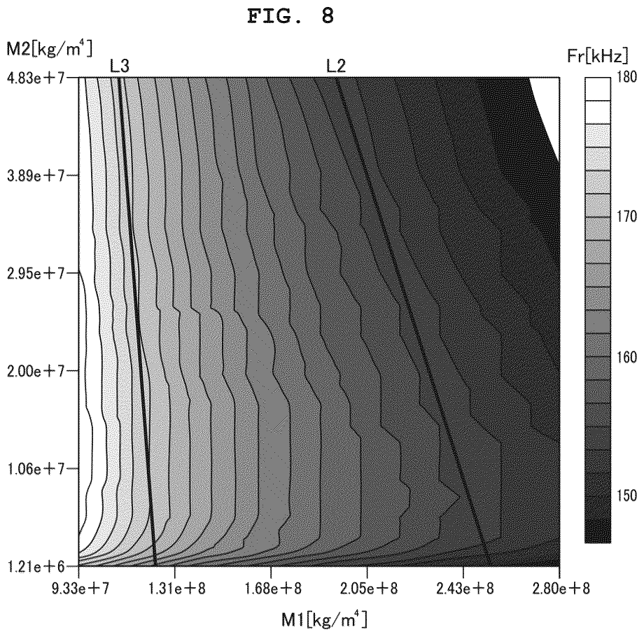

As appreciated from FIG. 8, a correlation is present among the inertance M1 of the third channel 23, the inertance M2 of the first channel 21, and the natural frequency Fr.

In FIG. 8, a straight line L2 is a line along the natural frequency Fr=155 kHz, and corresponds to an expression “M2=−8.37×10⁻¹×M1+2.20×10⁸”.

An area above the straight line L2 is an area in which the natural frequency Fr is less than 155 kHz. In this area, the natural frequency Fr is too low, and thus the drive frequency cannot be increased.

The straight line L2 and an area below the straight line L2 are areas in each of which the natural frequency Fris 155 kHz or more. In these areas, the natural frequency Fr is high, and thus the drive frequency can be increased.

In this regard, the head 1 of the present embodiment further satisfies the following expression (2). In other words, by allowing the natural frequency Fr to be in the straight line L2 and the area below the straight line L2 of FIG. 8, the drive frequency can be increased.

$$M 2 \leq - 8.37 \times 1 {0}^{- 1} \times M 1 + 2.2 \times 1 {0}^{8} \qquad Expression ( 2 )$$

In FIG. 8, a straight line L3 is a line along the natural frequency Fr=170 kHz, and corresponds to an expression “M2=−7.49×M1+9.83×10⁸”.

An area below the straight line L2 is an area in which the natural frequency Fr exceeds 170 kHz. In this area, since the natural frequency Fr is too high, the driving voltage applied to the piezoelectric element 13X becomes high, and the amount of the heat generated by the piezoelectric element 13X tends to increase easily.

An area above the straight line L3 is an area in which the natural frequency Fr is less than 170 kHz. In this area, since the natural frequency Fr is not too high, and the amount of the heat generated by the piezoelectric element 13X do not tend to increase easily.

In this regard, the head 1 of the present embodiment further satisfies the following expression (3). That is, by allowing the natural frequency Fr to be in the straight line L3 and the area above the straight line L3 of FIG. 8, the amount of the heat generated by the piezoelectric element 13X does not tend to increase easily.

$$M 2 \leq - 7.49 \times M 1 + 9.83 \times 1 {0}^{8} \qquad Expression ( 3 )$$

As described above, according to the present embodiment, by satisfying the above-described expressions (1) and (2) by the configuration of each of the communicating channel 12E and the first channel 21, rather than excessively increasing the rigidity of the pressure chamber 12P, the driving voltage applied to the piezoelectric element 13X can be made low, at a high driving frequency. Specifically, as appreciated from the above-described result of the analysis (see FIG. 6 and FIG. 7B), by satisfying the expression (1), the vibration velocity of the meniscus changes steeply even in a case where the driving voltage applied to the piezoelectric element 13X is low, and the ink droplet can be ejected from the nozzle 12N. As appreciated from the above-described result of the analysis (see FIG. 8), by satisfying the expression (2), the natural frequency Fr is 155 kHz or more, and the drive frequency can be increased.

In a case where the natural frequency Fr is too high, the drive voltage applied to the piezoelectric element 13X becomes high, and the amount of the heat generated by the piezoelectric element 13X tends to increase easily. In this regard, the head 1 according to the present embodiment satisfies the above-described expression (3); as appreciated from the above-described result of the analysis (see FIG. 8), the natural frequency Fr is 170 kHz or less. With this, the amount of the heat generated by the piezoelectric element 13X do not tend to increase easily.

Further, the head 1 according to the present embodiment satisfies the following expression (4). In a case where M2>M3 holds, the pressure wave is likely to be reflected in the first channel 21 of which the inertance is great, leading to a necessity for increasing the drive voltage applied to the piezoelectric element 13X in order to propagate the pressure wave up to the nozzle 12N. In this regard, the head 1 according to the present embodiment satisfies the following expression (4), so that the pressure wave is less likely to be reflected in the first channel 21, and the driving voltage applied to the piezoelectric element 13X can be made low more reliably.

$$M 2 \leq M 3 \qquad Expression ( 4 )$$

(In Expression (4), M3 is the inertance [kg/m⁴] of the nozzle 12N.)

The channel cross-sectional area of the hole defining the other end 21Y of the first channel 21 is smaller than the channel cross-sectional area of the one end 21X of the first channel 21 (see FIG. 4). The other end 21Y of the first channel 21 is a part which connects to the other end 12PY of the pressure chamber 12P. Since the inertance of this part is great, the high-order component of the pressure wave can be cut, and a satellite droplet can be prevented. The satellite droplet is generated in a case where the tail of an ink droplet separates from a main ink droplet, and the satellite droplet has a smaller volume than the volume of the main droplet.

Both the third channel 23 and the first channel 21 are located in the plate 11C which is one of the plates 11A to 11F (see FIG. 5). In this case, the third channel 23 and the first channel 21 can be formed in the same step, and thus the dimensional variation in each of the third channel 23 and the first channel 21 is reduced, satisfying the above-described expressions (1) and (2) more reliably. In contrast, in a case where the third channel 23 and the first channel 21 are located in separate plates, the third channel 23 and the first channel 21 are formed in separate steps. In this case, due to the overlap of dimensional variations occurring in the respective steps, the above-described expressions (1) and (2) might not be satisfied, in some cases.

The third channel 23 and the first channel 21 are located over the entire thickness of the plate 11C (see FIG. 5). In this case, the length in the vertical direction of each of the third channel 23 and the first channel 21 can be made constant, as compared to a case where the third channel 23 and the first channel 21 are located in a portion of the thickness of the plate 11C by the half etching, etc. Further, the above-described expressions (1) and (2) can be satisfied more reliably.

The one end 12PX and the other end 12PY in the conveying direction of the pressure chamber 12P are located in the central portion in the sheet-width direction of the pressure chamber 12P (see FIG. 4). In a case where the one end 12PX and the other end 12PY are located, respectively, at the one end and the other end in the sheet-width direction of the pressure chamber 12P, the propagation distance of the pressure wave in the pressure chamber 12P is long and the natural frequency Fr is low. In contrast, in the above-described configuration, the one end 12PX and the other end 12PY are located in the central portion in the sheet-width direction of the pressure chamber 12P, and thus the propagation distance is short and the natural frequency Fr is high. As a result, the driving frequency can be increased.

Further, the head 1 of the present embodiment satisfies the following expression (5). With this, the high-order component of the pressure wave can be cut and the satellite droplet can be prevented.

$$M 2 \geq 1.2 \times 1 {0}^{7} \qquad Expression ( 5 )$$

Next, another analysis performed by the inventors of the present disclosure will be described.

An example of the drive signal is depicted in FIG. 6.

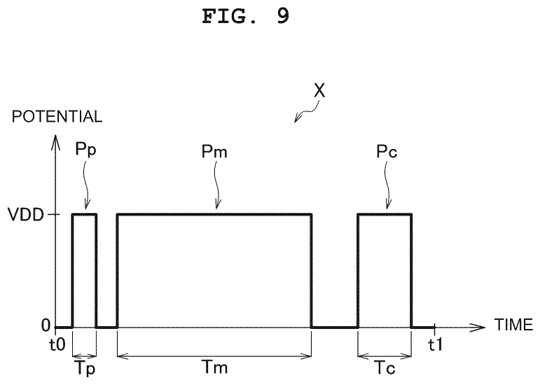

A drive signal X depicted in FIG. 9 includes three rectangular pulses within one ejection period (duration of time from time t0 to time t1) by which one dot is formed. The three pulses include a main pulse Pm, a pre-pulse Pp applied before the main pulse Pm, and a cancel pulse Pc applied after the main pulse Pm.

The main pulse Pm is configured to eject a predetermined volume of the ink droplet from the nozzle 12N. The pre-pulse Pp and the cancel pulse Pc are configured to prevent a satellite droplet, and have, respectively, a width Tp and a width Tc which are smaller than a width Tm of the main pulse Pm. The satellite droplet is generated in a case where the tail of an ink droplet separates from a main droplet of the ink droplet, and has a volume smaller than the volume of the main droplet. The pre-pulse Pp cancels a pressure wave, in the pressure chamber 12P, which has been generated in an ejection period before a current ejection period. The cancel pulse Pc cancels a pressure wave, in the pressure chamber 12P, which has been generated by the application of the main pulse Pm in the current ejection period.

The volume of the ink droplet ejected from the nozzle 12N changes in accordance with the width Tm of the main pulse Pm, realizing the gradation expression. However, the flying velocity of the ink droplet might also change depending on the width Tm. That is, the flying velocity of the ink droplet might vary among waveforms of which width Tm for the gradation expression are different. In a case where the flying velocity of the ink droplet varies, the image quality is consequently degraded.

The inventors of the present disclosure have found, as the result of diligent study and research, that the inertance of the third channel 23 (communicating channel 12E) and the inertance of the first channel 21 affect the drive voltage applied to the piezoelectric element 13X and that the drive voltage affects the vibration velocity of the meniscus formed in the nozzle 12N. The inertance of a channel is expressed as ρL/S [kg/m⁴] in a case where S [m²] is the cross-sectional area of the channel, L [m] is the length of the channel, and ρ [kg/m³] is the density of the ink in the channel.

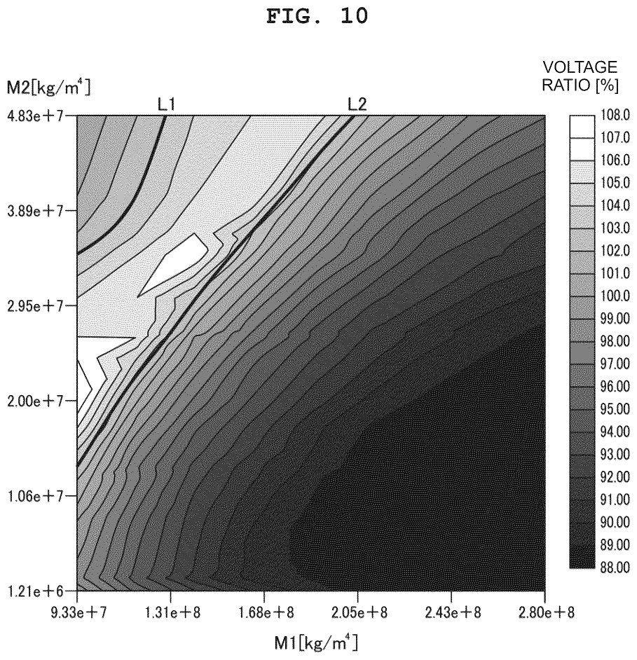

FIGS. 10 to 12 indicate the results of the analysis performed by the inventors of the present disclosure.

As appreciated from FIG. 10, a correlation is present among inertance M1 of the third channel 23 (communicating channel 12E), inertance M2 of the first channel 21, and the voltage ratio. The voltage ratio is a ratio obtained by setting the drive voltage to “1” in a case where the viscosity of the ink in the channel is 7 cps, the tension of the ink is 24 mN/m, the configuration other than the communicating channel 12E and the first channel 21 in the individual channel 12B is a predetermined configuration, and the flying velocity of the ink droplet ejected from the nozzle 12N becomes a predetermined velocity (for example, 7 m/s).

In FIG. 10, a curve L1 and a curve L2 are lines along the voltage ratio of 103%. The curve L1 can be approximated by an expression “M2=2.67×10⁻¹⁶×M1³−7.84×10⁻⁸×M1²+7.83×M1−2.31×10⁸”. The curve L2 can be approximated by an expression “M2=−6.02×10⁻¹⁰×M1²+4.88×10⁻¹×M1−2.66×10⁷”. Here, M1 is the inertance [kg/m⁴] of the third channel 23, and M2 is the inertance [kg/m⁴] of the first channel 21.

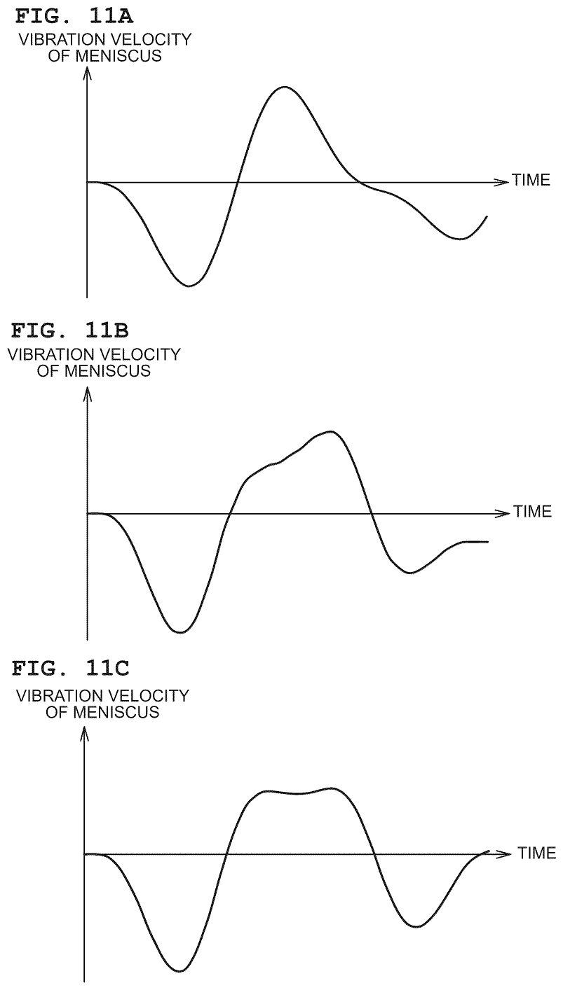

In an area above the curve L1, the vibration velocity of the meniscus changes as depicted in FIG. 11A. In an area below the curve L2, the vibration velocity of the meniscus changes as depicted in FIG. 11B. In these areas, the vibration velocity of the meniscus changes steeply.

In an area interposed between the curve L1 and the curve L2, the vibration velocity of the meniscus changes as depicted in FIG. 11C. In this area, the vibration velocity of the meniscus changes gradually.

In this regard, the head 1 of the present embodiment satisfies the following expressions (6) and (7). In other words, by allowing the vibration velocity of the meniscus to be in the area interposed between the curves L1 and L2 in FIG. 10, the vibration velocity of the meniscus changes gradually, and the flying velocity of the ink droplet does not tend to vary among the plurality of waveforms of which width Tm for the gradation expression are different.

$$M 2 \leq 2.67 \times 1 {0}^{- 16} \times M {1}^{3} - 7.84 \times 1 {0}^{- 8} \times M {1}^{2} + 7.83 \times M 1 - 2.31 \times 1 {0}^{8} \qquad Expression ( 6 )$$

$$M 2 \leq - 6.02 \times 1 {0}^{- 10} \times M {1}^{2} + 4.88 \times 1 {0}^{- 1} \times M 1 - 2.66 \times 1 {0}^{7} \qquad Expression ( 7 )$$

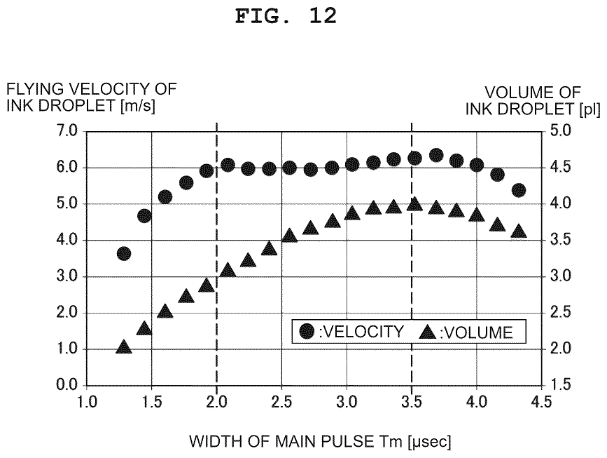

In a case where the width Tm is changed in the head 1 which satisfies the above-described expressions (6) and (7), the flying velocity and the volume of the ink droplets change as depicted in FIG. 12. As appreciated from FIG. 12, in a case where the width Tm is in a range of 2.0 usec, to 3.5 μsec, the flying velocity changes gradually. Therefore, in the present embodiment, the width Tm is set in the range of 2.0 usec to 3.5 μsec.

Further, in order to drive the head 1 at the high drive frequency desired by the inventors of the present disclosure, the natural frequency Fr is preferably 150 kHz or more.

As described above, according to the present embodiment, the natural frequency Fr is 150 kHz or more, and thus the drive frequency can be increased, and the high-speed recording can be realized. Furthermore, as appreciated from the above-described result of the analysis, by satisfying the expressions (6) and (7), the flying velocity of the ink droplet do not tend to vary among the plurality of waveforms for the gradation expression.

Further, the head 1 of the present embodiment satisfies the following expression (8). In a case where M2>M3 holds, the pressure wave is likely to be reflected in the second channel 22 of which inertance is great, and thus the drive voltage applied to the piezoelectric element 13X is required to be increased so as to propagate the pressure wave up to the nozzle 12N. In this regard, by satisfying the following expression (8), the present embodiment makes the pressure wave less likely to be reflected in the second channel 22, and can make the drive voltage applied to the piezoelectric element 13X low in a more reliable manner.

$$M 2 \leq M 3 \qquad Expression ( 8 )$$

(In Expression (8), M3 is the inertance [kg/m⁴] of the nozzle 12N.)

The channel cross-sectional area of the hole constructing the other end 21Y of the first channel 21 is smaller than the channel cross-sectional area of the one end 21X of the first channel 21 (see FIG. 4). The other end 21Y of the first channel 21 is a portion connecting to the other end 12PY of the pressure chamber 12P. By making the inertance of this portion great, the high-order component of the pressure wave can be cut and the satellite droplet can be prevented.

Both the third channel 23 and the first channel 21 are located in the plate 11C which is one of the plates 11A to 11F (see FIG. 5). In this case, the third channel 23 and the first channel 21 are formed by the same plate 11C, and thus the manufacturing variation in each of the third channel 21 and the first channel 21 is reduced, thereby satisfying the above-described expressions (6) and (7) more reliably.

The third channel 23 and the first channel 21 are located over the entire thickness of the plate 11C (see FIG. 5). In this case, the length in the vertical direction of each of the third channel 23 and the first channel 21 can be made constant, as compared to a case where the third channel 23 and the first channel 21 are located in a portion of the thickness of the plate 11C by the half etching, etc. Further, the above-described expressions (6) and (7) can be satisfied more reliably.

The one end 12PX and the other end 12PY in the conveying direction of the pressure chamber 12P are located in the central portion in the sheet-width direction of the pressure chamber 12P (see FIG. 4). In a case where the one end 12PX and the other end 12PY are located, respectively, at the one end and the other end in the sheet-width direction of the pressure chamber 12P, the propagation distance of the pressure wave in the pressure chamber 12P is long and the natural frequency Fr is low. In contrast, in the present embodiment, the one end 12PX and the other end 12PY in the conveying direction of the pressure chamber 12P are located in the central portion in the sheet-width direction of the pressure chamber 12P, and thus the propagation distance of the pressure wave in the pressure chamber 12P is short and the natural frequency Fr is high. Accordingly, the requirement that the natural frequency FR is 150 kHz or more can be satisfied more reliably.

Further, the present embodiment satisfies the following expression (9). With this, the high-order component of the pressure wave can be cut and the satellite droplet can be prevented.

$$M 2 \geq 1.2 \times 1 {0}^{7} \qquad Expression ( 9 )$$

The width Tm of the main pulse Pm is in the range of 2.0 usec to 3.5 μsec. As appreciated from the above-described result of the analysis (see FIG. 12), in a case where the width Tm is in the range of 2.0 μsec to 3.5 μsec, the effect of preventing the variation in the flying velocity of the ink droplet in the plurality of waveforms for the gradation expression can be obtained more reliably.

Further, the present embodiment is desired to satisfy the following expressions (10) and (11). In a case where M1<9.0×10⁷ holds, the residual vibration in the pressure chamber 12P cannot be reduced easily. In a case where M2>5.0×10⁷ holds, the pressure wave cannot propagate easily up to the nozzle 12N. The above-described problems can be solved by satisfying the following expressions (10) and (11).

$$M 1 \geq 9.0 \times 1 {0}^{7} \qquad Expression ( 10 )$$

$$M 2 \leq 5. \times 1 {0}^{7} \qquad Expression ( 11 )$$

### Second Embodiment

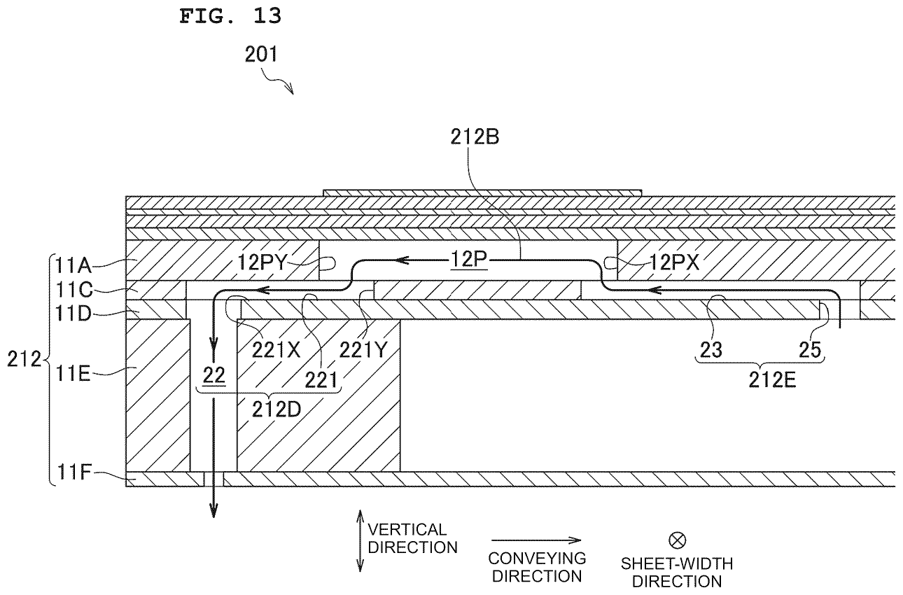

The channel member 12 of the head 1 according to the first embodiment has the six plates 11A to 11F, as depicted in FIG. 5. In contrast, a channel member 212 of the head 201 according to the second embodiment has five plates 11A and 11C to 11F, as depicted in FIG. 13. That is, in the second embodiment, the plate 11B is omitted.

As a result, in the second embodiment, the vertical holes 24, 26 (see FIG. 5) are absent, a third channel 23 is directly connected to one end 12PX of a pressure chamber 12P, and a first channel 221 is directly connected to other end 12PY of the pressure chamber 12P. A connecting channel 212D does not include the vertical hole 26, but includes the first channel 221 and a second channel 22. A communicating channel 212E does not include the vertical hole 24, but includes a third channel 23 and a vertical hole 25.

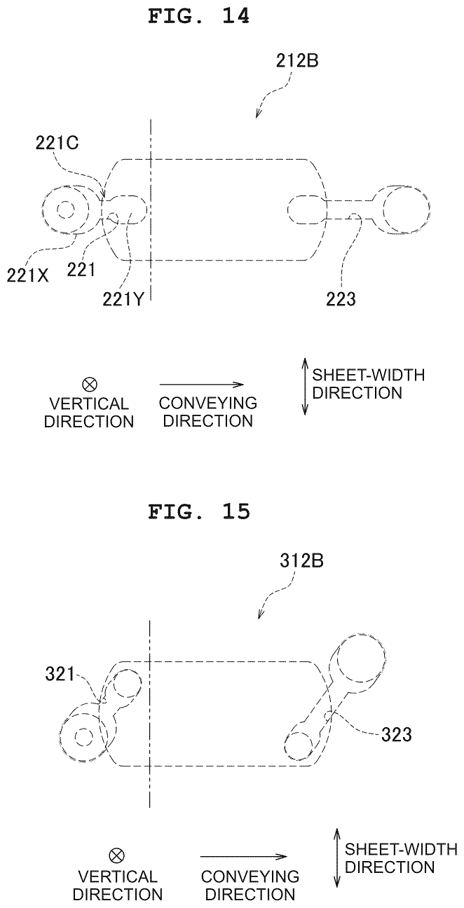

Further, in the individual channel 12B of the first embodiment, the channel width of the first channel 21 decreases smaller from the upstream toward the downstream in the conveying direction, as depicted in FIG. 4. In contrast, in an individual channel 212B of the second embodiment, the channel width of the first channel 221 is made locally small between one end 221X and the other end 221Y of the first channel 221A, as depicted in FIG. 14.

In the first channel 221, the portion of which channel width is locally made small is a narrowed portion 221C. The channel cross-sectional area of the narrowed portion 221C is smaller than both the channel cross-sectional area of the one end 221 X of the first channel 221 and the channel cross-sectional area of the other end 221Y of the first channel 221.

As described above, according to the second embodiment, the other end 221Y of the first channel 221 is connected to the pressure chamber 12P (see FIG. 13), not via the vertical hole 26 (see FIG. 5). In this case, by directly connecting the first channel 221, of which inertance is great, to the pressure chamber 12P, the high-order component of the pressure wave can be cut more efficiently, and the satellite droplet can be prevented more reliably.

Further, according to the second embodiment, the high-order component of the pressure wave can be cut by the narrowed portion 221C of which inertance is great, and the satellite droplet can be prevented.

Furthermore, in the second embodiment, the one end and the other end of the first channel 221 and the one end and the other end of the third channel 223 are oval, rather than perfectly circular, in the plane orthogonal to the vertical direction.

### Third Embodiment

In the individual channel 12B of the first embodiment, the first channel 21 and the third channel 23 extend in the conveying direction as depicted in FIG. 4. In contrast, in an individual channel 312B of the third embodiment, a first channel 321 and a third channel 323 extend in a direction inclined with respect to both the conveying direction and the sheet-width direction, as depicted in FIG. 15.

According to the third embodiment, the first channel 321 and the third channel 323 extend in the inclined direction, and thus the size in the conveying direction in the entirety of the individual channel 312B including the first channel 321 and the third channel 323 can be made small.

Note that in the third embodiment, in a similar manner as in the second embodiment, the one end and the other end of the first channel 321 and the one end and the other end of the third channel 323 are oval, rather than perfectly circular, in the plane orthogonal to the vertical direction.

### Fourth Embodiment

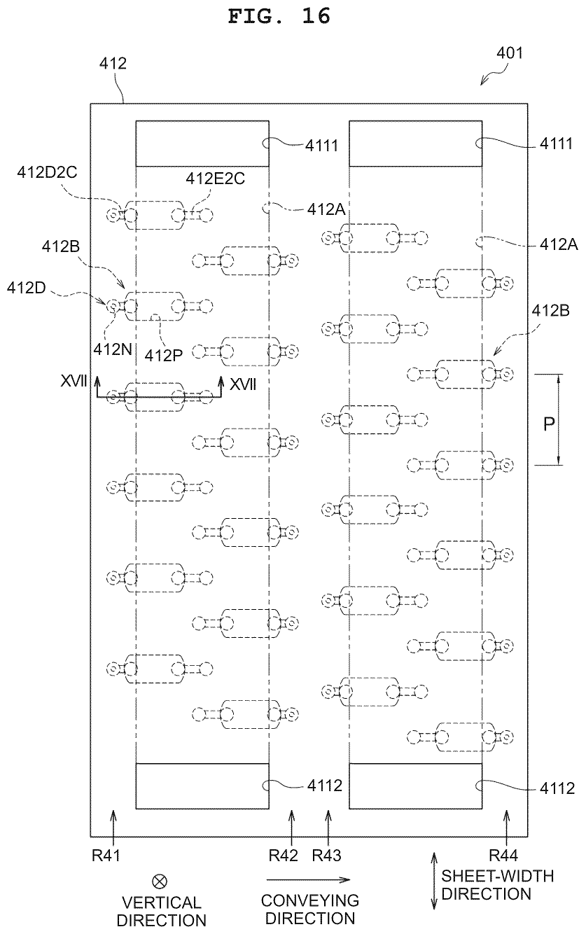

As depicted in FIG. 16, two supply ports 4111 and two return ports 4112 are open in the upper surface of a channel member 412 of the fourth embodiment. The two supply ports 4111 are located at one end in the sheet-width direction of the channel member 412. The two return ports 4112 are located at the other end in the sheet-width direction of the channel member 412. Each of the supply ports 4111 and the return ports 4112 is connected to an ink tank via a tube.

The channel member 412 has two common channels 412A and a plurality of individual channels 412B.

The two common channels 412A are located side by side in the conveying direction, and each extend in the sheet-width direction. Each of the two supply ports 4111 is connected to one end in the sheet-width direction of a corresponding common channel 412A of the two common channels 412A. Each of the return ports 4112 is connected to the other end in the sheet-width direction of a corresponding common channel 412A of the two common channels 412A. The two common channels 412A communicate with the ink tank via the two supply ports 4111 and the two return ports 4112, respectively, and communicate with the plurality of individual channels 412B.

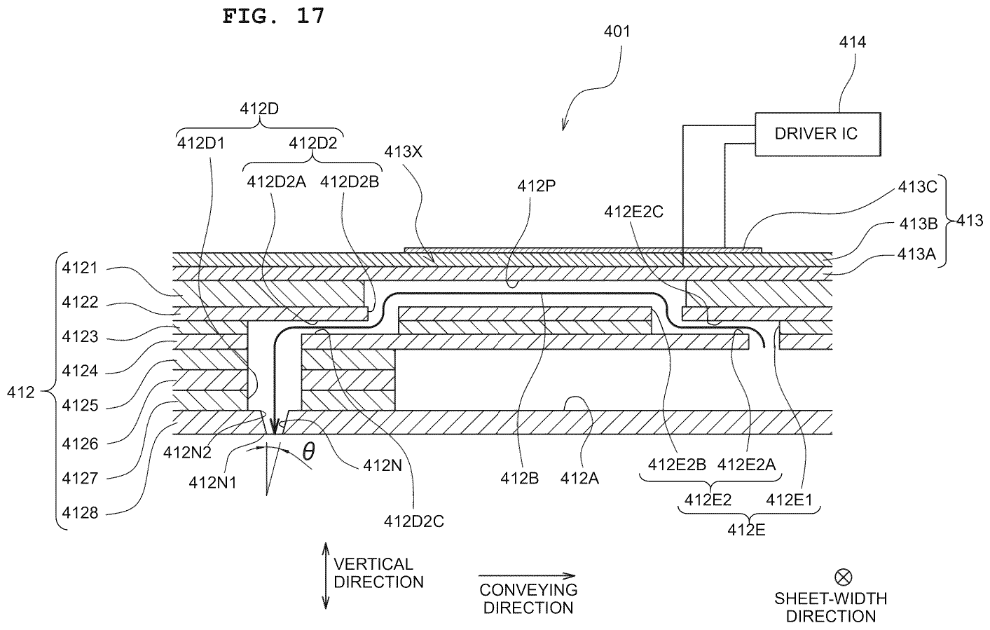

As depicted in FIG. 17, each of the plurality of individual channels 412B includes a nozzle 412N, a pressure chamber 412P, a first communicating channel 412D and a second communicating channel 412E. One end of the first communicating channel 412D communicates with the nozzle 412N, and the other end of the first communicating channel 412D communicates with the pressure chamber 412P. One end of the second communicating channel 412E communicates with the common channel 412A, and the other end of the first communicating channel 412D communicates with the pressure chamber 412P. The first communicating channel 412D communicates with one end of the pressure chamber 412P, and the second communicating channel 412E communicates with the other end of the pressure chamber 412P.

The channel member 412 includes eight plates 4121 to 4128. Note that the channel member 412 may be constructed of eight or more plates, or seven or less plates. The plates 4121 to 4128 are stacked in the vertical direction and adhered to one another. Pressure chambers 412P, each of which is included in a corresponding individual channel 412B of the plurality of individual channels 412B, are formed in the plate 4121 which is the uppermost layer among the eight plates 4121 to 4128; and nozzles 412N, each of which is included in a corresponding individual channel 412B of the plurality of individual channels 412B, are formed in the plate 4128 which is the lowermost layer among the eight plates 4121 to 4128.

The plurality of pressure chambers 412P are open in the upper surface of the plate 4121, and the plurality of nozzles 412N are open in the lower surface of the plate 4127. The opening of the nozzle 412N is circular, and the opening of the pressure chamber 412P is substantially rectangular which is long in the conveying direction. Namely, the width in the sheet-width direction of the pressure chamber 412P is shorter than the length in the conveying direction of the pressure chamber 412P.

As depicted in FIG. 17, the nozzle 412N has a shape tapered downward. The lower end of the nozzle 412N is an outlet 412N1 of an ink droplet ejected from the nozzle 412N. The diameter of the outlet 412N1 of the nozzle 412N is smaller than the upper end of the nozzle 412N, i.e., an entrance 412N2 to the nozzle 412N. In the fourth embodiment, a sidewall defining the nozzle 412N is inclined with respect to the vertical direction. A taper angle θ of the nozzle 412N is an angle of the acute angle side, of the sidewall defining the nozzle 412N, with respect to the vertical direction.

As depicted in FIG. 17, the first communicating channel 412D has a first portion 412D1 and a second portion 412D2. The first portion 412D1 is connected to the upper end of the nozzle 412N and has a cylindrical shape. The first portion 412D1 defines one end, of the first communicating channel 412D, which is connected to the nozzle 412N. The first portion 412D1 extends in an up direction from the nozzle 412N (in a direction approaching the pressure chamber 412P) and is located at a position at which the first portion 412D1 does not overlap with the pressure chamber 412P in the up direction. The first portion 412D1 is defined by holes each of which is formed in one of the four plates 4124 to 4127 and which are connected with one another; the first portion 4121D1 has a diameter greater than the diameter of the inlet 412N2 of the nozzle 412N.

The second portion 412D2 has a horizontal portion 412D2A connected to the upper end of the first portion 412D1 and a vertical portion 412D2B connected to the pressure chamber 412P. The horizontal portion 412D2A is a hole formed in the plate 4123, and extends from the upper end (downstream end in the up direction) of the first portion 412D1 along the conveying direction. In other words, the horizontal portion 412D2A extends from the upper end of the first portion 412D1 toward the pressure chamber 412P in parallel with the upper surface of the channel member 412 (a plane in which the pressure chamber 412P is located). Further, as depicted in FIGS. 16 and 17, the horizontal portion 412D2A has a throttle portion 412D2C which throttles the flow amount of the liquid. The throttle portion 412D2C is formed in a central portion in the conveying direction of the horizontal portion 412D2A, and the channel width of the throttle portion 412D2C is smaller than the channel width of the first portion 412D1. Here, the term “channel width” means the width in the sheet-width direction. In the fourth embodiment, the both end portions in the conveying direction of the horizontal portion 412D2A have a channel width greater than the channel width of the narrowed portion 412D2C. However, the channel width of the horizontal portion 412D2A may be constant over the entire length of the horizontal portion 412D2A.

As depicted in FIG. 17, the vertical portion 412D2B is a hole formed in the plate 4122, and extends upward from an end, of the horizontal portion 412D2A, which is close to the pressure chamber 412P (a downstream end in the direction in which the horizontal portion 412D2A extends from the first portion 412D1) toward the pressure chamber 412P. In this manner, the second portion 412D2 is defined by holes which are formed, respectively, in the two plates 4122 and 4123 and which are connected to each other.

As depicted in FIG. 17, the second communicating channel 412E has a first portion 412E1 and a second portion 412E2. The first portion 412E1 is a hole formed in the plate 4124 and is connected to an upper end of the common channel 412A.

The second portion 412E2 has a horizontal portion 412E2A connected to an upper end of the first portion 412E1 and a vertical portion 412E2B connected to the pressure chamber 412P. The horizontal portion 412E2A is a hole formed in the plate 4123, and extends from an upper end of the first portion 412E1 toward the pressure chamber 412P along the conveying direction. Further, the horizontal portion 412E2A has a throttle portion 412E2C which throttles the flow amount of the liquid, as depicted in FIGS. 16 and 17. The throttle portion 412E2C is formed in a center portion in the conveying direction of the horizontal portion 412E2A, and has a channel width which is smaller than the channel width of the first portion 412E1. In the fourth embodiment, although the channel width at the both end portions in the conveying direction of the horizontal portion 412E2A is greater than the channel width of the throttle portion 412E2C, the horizontal portion 412E2A may have a channel width which is constant over the entire length of the horizontal portion 412E2A.

As depicted in FIG. 17, the vertical portion 412E2B is a hole formed in the plate 4122, and extends upward from an end, of the horizontal portion 412E2A, which is close to the pressure chamber 412P toward the pressure chamber 412P. In such a manner, the second portion 412E2 is defined by holes formed, respectively, in the two plates 4122 and 4123 and connected to each other.

As depicted in FIG. 16, the plurality of nozzles N are located in a staggered manner in the sheet-width direction and construct four nozzle rows R41 to R44. Each of the nozzle rows R41 to R44 is constructed of nozzles N, of the plurality of nozzles N, which are aligned in the sheet-width direction.

In each of the nozzle rows R41 to R44, the nozzles 412N are located at a pitch P of 300 dpi or more in the sheet-width direction. In the fourth embodiment, the recording resolution in each of the nozzle rows R41 to R44 is 300 dpi, and the pitch P is approximately 84 μm. Here, the term “recording resolution” means a resolution of an image recorded by ink droplets ejected from the nozzles 412N.

Between two nozzle rows which are included in the four nozzle rows R41 to R44 and which are adjacent to each other in the conveying direction, the positions in the sheet-width direction of the nozzles N are shifted by half the pitch P. With this, in a case where the recording resolution in each of the nozzle rows R41 to R44 is 300 dpi, a recording resolution of 1200 dpi is realized by the four nozzle rows R41 to R44. The head 1 of the fourth embodiment has a recording resolution of 1200 dpi×1200 dpi in the sheet-width direction and the conveying direction.

The ink in the ink tank is supplied to each of the two common channels 412A via a corresponding supply port 4111 of the two supply ports 4111 by driving of the pump 10 depicted in FIG. 2 under the control of the controller 5, and the ink is then distributed from the two common channel 412A to the plurality of individual channels 412B.

In the individual channel 412B, in a case where the volume of the pressure chamber 412P decreases by driving of the piezoelectric element 13X which will be described later, pressure is applied to the ink in the pressure chamber 412P, thereby causing the ink to pass through the first communicating channel 412D and to be ejected as an ink droplet from the nozzle 412N.

The ink which is supplied to each of the two common channels 412A via the corresponding supply port 4111 moves inside each of the two common channels 412A from the one end toward the other end in the sheet-width direction thereof, and reaches a corresponding return port 4112 of the two return ports 4112. The ink which has reached the corresponding return port 4112 is returned to the ink tank via the tube.

As depicted in FIG. 17, the actuator member 13 is fixed to the upper surface of the channel member 412. The actuator member 413 includes a metallic vibration plate 413A, a piezoelectric layer 413A, and a plurality of individual electrodes 413C.

In the actuator member 413, portions each of which overlaps with a corresponding pressure chamber 412P of the plurality of pressure chambers 412P in the vertical direction function as a plurality of piezoelectric elements 413X. Each of the plurality of piezoelectric elements 413X can be deformed independently according to the potential applied to each of the plurality of individual electrodes 413C.

Each of the plurality of piezoelectric elements 413X is a thin film piezoelectric element. The thin film piezoelectric element is a so-called micro electro mechanical systems (MEMS). Each of the plurality of piezoelectric elements 413X is formed by sequentially depositing a thin film which becomes the piezoelectric layer 413B and a thin film which becomes the plurality of individual electrodes 413C, on the upper surface of the vibration plate 413A.

The vibration plate 413A is disposed on the upper surface of the channel member 412 so as to cover the plurality of pressure chambers 412P. The piezoelectric layer 413B is disposed on the upper surface of the vibration plate 413A. The plurality of individual electrodes 413C are disposed on the upper surface of the piezoelectric layer 413B such that each of the plurality of individual electrodes 413C overlaps with a corresponding pressure chamber 412P of the plurality of pressure chambers 412P in the vertical direction.

The vibration plate 413A and the plurality of individual electrodes 413C are electrically connected to a driver IC 414. The driver IC 414 maintains the potential of the vibration plate 413A at the ground potential, whereas the driver IC 414 changes the potential of each of the plurality of individual electrodes 413C. The vibration plate 413A functions as a common electrode which is common to the plurality of piezoelectric elements 413X.

The driver IC 414 generates a drive pulse signal based on a control signal from a controller 45, and supplies the drive pulse signal to each of the plurality of individual electrodes 413C. The drive pulse signal changes the potential of each of the plurality of individual electrodes 413C between a predetermined driving potential and the ground potential. In such a manner, each of the plurality of piezoelectric elements 413X is driven to thereby apply the pressure to the ink inside a corresponding pressure chamber 412P, causing the ink to pass through the first communication channel 412D and to be ejected, as an ink droplet, from the nozzle 412N.

Next, the analysis performed by the inventors of the present disclosure will be described.

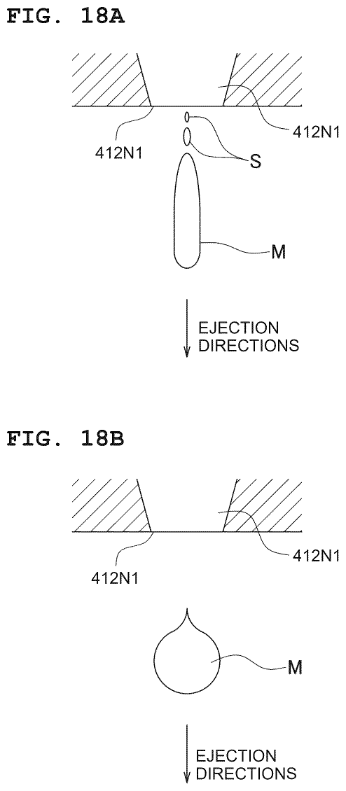

In a case where an ink droplet ejected from the nozzle 412N has a shape which is elongated along an ejecting direction, as depicted in FIG. 18A, the ink droplet tends to easily separate into a main droplet M and a satellite droplet S. Since the satellite droplet S is a fine liquid droplet, the satellite droplet S is likely to become a mist floating in the air. Further, in a case where satellite droplets S are generated from the ink droplet, an ink volume of the main droplet M is reduced and does reach a predetermined volume. On the other hand, in a case where the ink droplet ejected from nozzle 412N has a shape which is substantially spherical, as depicted in FIG. 18B, the ink droplet is less likely to separate into the main droplet M and the satellite droplet S, and is constructed substantially only of the main droplet M. As a result, the ink volume of the ink droplet is the predetermined volume.

In this regard, the inventors of the present disclosure have analyzed the relationship between a meniscus flowing velocity in the nozzle 412N and the shape of the ink droplet in a case where an ink droplet is ejected from the nozzle. As a result, the inventors have found that the slower the meniscus flowing velocity, the greater the radius of the ink droplet ejected from the nozzle 412N, and further the ink droplet is formed substantially into a spherical shape. The meniscus flowing velocity indicates a velocity at which the meniscus oscillates in the ejecting direction of the ink droplet due to a pressure wave generated at the inlet 412N2 of the nozzle 412N (i.e., the one end of the first communicating channel 412D) by the driving of the piezoelectric element 13X with the driving pulse signal. The meniscus flowing velocity has been obtained by performing image analysis of the change in the meniscus from a position of the meniscus closest to the inlet 412N2 of the nozzle 412N to a position of the meniscus closest to the outlet 412N1 in a case where the ink droplet is ejected from the nozzle 412N. More specifically, the inventors have obtained the meniscus flowing velocity by dividing a number of changed pixels wherein a number of pixels indicating an ink portion inside the nozzle 412N in which the meniscus approaches the inlet 412N2 most closely is changed to a number of pixels indicating an ink portion inside the nozzle 412N in which the meniscus approaches the outlet 412N2 most closely, by a time (μs) required for the meniscus to undergo the above-described change.

In a case where the piezoelectric element 413X is driven by the drive pulse signal, the pressure wave is generated between the pressure chamber 412P and the nozzle 412N. The shape of the pressure wave depends greatly on the shape of the first communicating channel 412D.

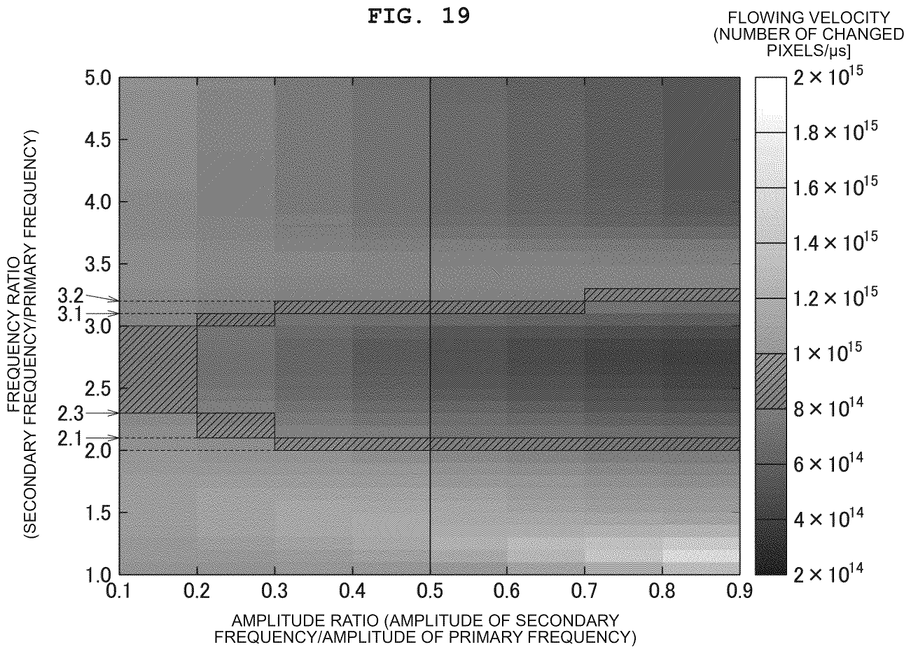

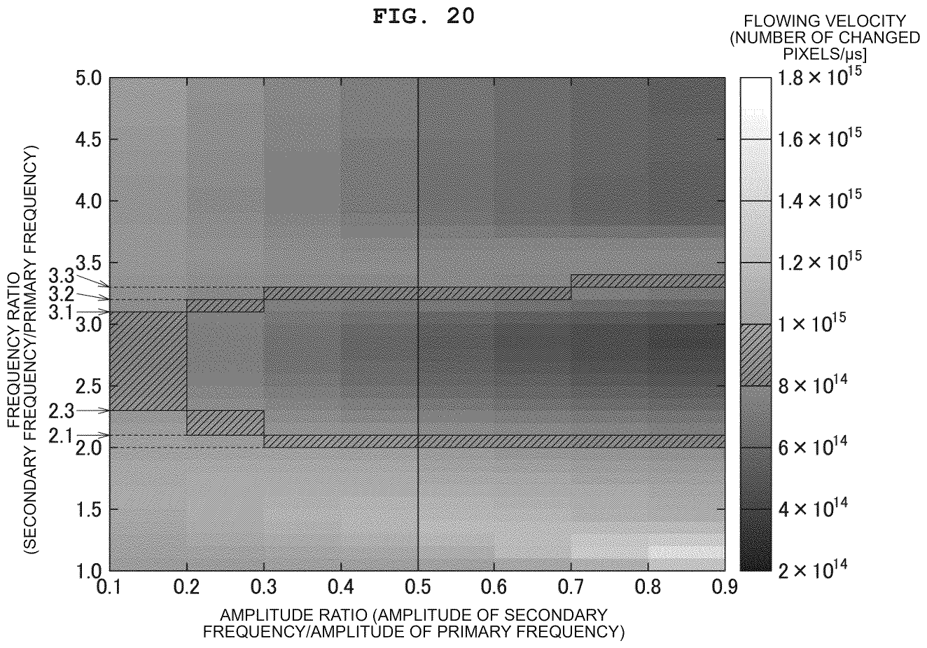

In this regard, the inventors of the present disclosure have performed Fast Fourier Transformation (FFT) analysis of the pressure waves generated at the inlet 412N2 of the nozzle 412N in cases where the drive frequency by which the piezoelectric element 13X was driven, respectively, at 150 kHz and at 200 kHz in analytical models in which the shape and size of the first communicating channel 412D were variously changed, and the inventors have obtained frequency characteristics at the inlet 412N2. Further, the inventors have obtained a frequency ratio of the secondary frequency to the primary frequency of the plurality of frequency characteristics at each of the drive frequencies, and an amplitude ratio of the amplitude of the secondary frequency to the amplitude of the primary frequency. The primary frequency in each of the plurality of frequency characteristics is substantially determined by the pressure applied to the pressure chamber 412P and is equal to the drive frequency. The secondary frequency is a frequency at which the peak of the next amplitude of the primary frequency appears. Higher-order frequencies beyond the secondary frequency have smaller amplitudes than the amplitude of the secondary frequency and have substantially no effect on the shape of the ejected ink droplet. Further, the inventors have also obtained the meniscus flowing velocities at the drive frequency of 150 kHz and at the drive frequency of 200 kHz in the above analytical models. The result of the analysis is indicated in FIGS. 19 and 20.

FIG. 19 depicts, in a case where the drive frequency is 150 kHz, with the vertical axis representing the frequency ratio and the horizontal axis representing the amplitude ratio, a meniscus flowing velocity corresponding thereto in gray scale. FIG. 20 depicts, in a case where the drive frequency is 200 kHz, with the vertical axis representing the frequency ratio and the horizontal axis representing the amplitude ratio, a meniscus flowing velocity corresponding thereto in gray scale. Note that the shape of the pressure chamber 412P and the shape of the nozzle 412N in the above-described analysis model are all the same. A pulse width of the drive pulse signal in a case where the drive frequency is 150 kHz is 3.1 μs, and a pulse width of the drive pulse signal in a case where the drive frequency is 200 kHz is 2.5 μs.

In a case where the meniscus flowing velocity becomes 1×10¹⁵ (number of changed pixels/μs) or less, the ink droplet ejected from nozzle 412N is formed substantially into a spherical shape and the ink amount becomes the predetermined volume or more. Meniscus flowing velocities each as the boundary wherein the ink amount becomes the predetermined amount or more are indicated by hatching in FIGS. 19 and 20.

In a case where the shape of the first communicating channel 412D is changed to cause the secondary frequency to be approximated to the primary frequency, the amplitude of the secondary frequency is reduced, and most of the amplitude ratios of the secondary frequency to the primary frequency are 0.5 or less. Furthermore, in a case where the amplitude ratio exceeds 0.5, the amplitude ratio exceeding 0.5 affects the amplitude of the primary frequency and reduces the amount of ink droplet. For this reason, the amplitude ratio is preferably 0.5 or less. This affects the amplitude of the primary frequency and prevents the amount of ink droplet from becoming small.

In FIG. 19, the maximum range of frequency ratios wherein the amplitude ratio is 0.5 or less and the meniscus flowing velocity realizes the amount of ink which is the predetermined amount or more is in a range of 2.0 to 3.2. The range of frequency ratio becomes narrower as the amplitude ratio becomes smaller. More specifically, in a case where the amplitude ratio is 0.3 or more and 0.5 or less, the range of frequency ratio is in a range of 2.0 to 3.2. In a case where the amplitude ratio is 0.2 or more and 0.3 or less, the range of frequency ratio is in a range of 2.1 to 3.1. In a case where the amplitude ratio is 0.1 or more and 0.2 or less, the range of frequency ratio is in a range of 2.3 to 3.0.

Therefore, the channel member 412 is configured to have the first communicating channel 412D satisfying, in a case where the piezoelectric element 413X is driven at the drive frequency of 150 kHz, the range of frequency ratio as the boundary wherein the ink amount becomes the predetermined amount or more is within the range depicted in FIG. 19.

In FIG. 20, the maximum range of frequency ratios wherein the amplitude ratio is 0.5 or less and the meniscus flowing velocity realizes the amount of ink which is the predetermined amount or more is in a range of 2.0 to 3.3. In a case where the drive frequency is 200 kHz, the upper limit of the frequency ratios is slightly higher than the upper limit of the frequency ratios in a case where the drive frequency is 150 kHz, but the lower limit of the frequency ratios in the case where the drive frequency is 200 kHz is almost the same as the lower limit of the frequency ratios in the case where the drive frequency is 150 kHz.

Further, in FIG. 20 also, the range of frequency ratios becomes narrower as the amplitude ratio becomes smaller, in a similar manner as in FIG. 19. More specifically, in a case where the amplitude ratio is 0.3 or more and 0.5 or less, the range of frequency ratio is in a range of 2.0 to 3.3. In a case where the amplitude ratio is 0.2 or more and 0.3 or less, the range of frequency ratio is in a range of 2.1 to 3.2. In a case where the amplitude ratio is 0.1 or more and 0.2 or less, the range of frequency ratio is in a range of 2.3 to 3.1.

Therefore, the channel member 412 is configured to have the first communicating channel 412D satisfying, in a case where the piezoelectric element 413X is driven at the drive frequency of 200 kHz, the range of frequency ratio as the boundary wherein the ink amount becomes the predetermined amount or more is within the range depicted in FIG. 20.

As described above, according to the head 1 of the fourth embodiment, the ink droplet ejected from the nozzle 412N can be formed into a substantially spherical shape with the channel member 412 configured so as to satisfy that the frequency ratio is in the range of 2.0 to 3.2, without performing the complicated voltage control. In this case, the ejected ink droplet is less likely to separate into the main droplet and the satellite droplet, and the generation of mist due to the satellite droplet can be prevented.

In a case where the drive frequency, i.e., the primary frequency, is 150 kHz or more, the channel member 412 is preferably configured to satisfy so that the frequency ratio is within the range of 2.0 to 3.2. This configuration can prevent the generation of mist even in a case where high-speed ejection to eject ink droplets from the nozzle 412N is performed with a short ejection interval.

Further, in a case where the drive frequency, i.e., the primary frequency, is 200 kHz or less, the channel member 412 is preferably configured so as to satisfy that the frequency ratio is within the range of 2.0 to 3.3. This prevents the amount of ink droplet ejected from the nozzle 412N from becoming less than the predetermined amount. In a case where the drive frequency exceeds 200 kHz, the pulse width in the drive pulse signal becomes less than 2.5 μs. As the pulse width becomes small, the pressure applied to the ink in the pressure chamber 412P also becomes small, and the amount of ink droplet ejected from the nozzle 412N becomes less than the predetermined amount.

Furthermore, the amplitude of the secondary frequency satisfies that the amplitude of the secondary frequency is 0.5 times or less the amplitude of the primary frequency. Accordingly, even in a case where the channel member 412 is configured so as to satisfy that the frequency ratio is in the range of 2.0 to 3.3, the amount of the ink droplet ejected from the nozzle 412N can be maintained at the predetermined amount. Moreover, the generation of mist can be effectively prevented.

Further, the first communicating channel 412D has the throttle portion 412D2C. This significantly reduces the higher-order frequencies beyond the secondary frequency in the frequency characteristics in the inlet 412N2 of the nozzle 412N. Further, the secondary frequency can be easily approximated to the primary frequency. This easily realizes the configuration of the channel member 412 in which the frequency ratio is in the range of 2.0 to 3.2.

As a modification, the inventors of the present disclosure have changed the diameter of the outlet 412N1, of the nozzle 412N of the analytical models in the above-described embodiment, in a range of 10 μm to 50 μm, and the inventors have performed a similar analysis. Also in this analytical models, the results were almost the same as the plurality of analytical results as depicted in FIGS. 19 and 20. However, in a case where the diameter of the outlet 412N1 is 14 μm or less, the amount of ink droplet itself ejected from the nozzle 412N is less than the predetermined amount. Therefore, the diameter of the outlet 412N1 is preferably 14 μm or more. This prevents the amount of ink droplet ejected from the nozzle 412N from being less than the predetermined amount.

Further, in a case where the diameter of the outlet 412N1 exceeds 30 μm, the ejection velocity of the ink droplet from the nozzle 412N becomes smaller than the predetermined velocity. Therefore, the diameter of the outlet 412N1 is preferably 30 μm or less. This prevents the ejection velocity of the ink droplets ejected from the nozzle 412N from becoming smaller than the predetermined velocity.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

Although the present disclosure has been described above regarding the embodiment, the present disclosure is not limited to the above-described embodiment. Various changes can be made to the present disclosure, within the scope of the claims.

In the above-described embodiments, although the first communicating channel 412D has the throttle portion 412D2C, the throttle portion 412D2C may be omitted in the first communicating channel 412D. In other words, the channel member 412 may be configured so as to satisfy that the frequency ratio is in the range of 2.0 to 3.2. This also realizes the same effect as described above.

Further, the first communicating channel 412D may entirely overlap with the pressure chamber 412P along the vertical direction. In this case, the nozzle 412N may also overlap with the pressure chamber 412P along the vertical direction. This reduces the size of the channel member 412.

Furthermore, in a case where the drive frequency is 200 kHz, the channel member 412 may be configured to satisfy that the frequency ratio is within the range of 2.0 to 3.3. This realizes the same effect as described above.

In a case where a set amount itself of the ink amount of the ink droplet ejected from the nozzle 412N is small, the diameter of the outlet 412N1 of the nozzle 412N may be in a range of 10 μm to less than 14 μm. In a case where a set ejection velocity itself of the ink droplet ejected from the nozzle 412N is slow, the diameter of the outlet 412N1 of the nozzle 412N may be in a range of 31 μm to 50 μm.

Moreover, the horizontal portion 412D2A described above has the throttle portion 412D2C of which channel width is narrow and which is formed in the central portion in the extending direction (conveyance direction) of the horizontal portion 412D2A, but the channel width may be smaller than the channel width of the first section 412D1, over the entire length of the horizontal portion 412D2A.

In the above-described first to fourth embodiments, although the electrodes constructing the piezoelectric element have a two-layered structure including the individual electrodes and the common electrode, the electrodes constructing the piezoelectric element may have a three-layered structure. For example, the three-layered structure means a configuration including a driving electrode to which a high potential and a low potential is selectively applied, a high potential electrode which is maintained at the high potential and a low potential electrode which is maintained at the low potential.

The piezoelectric element may be a thin film piezoelectric element.

The pressure chamber is not limited to being long in the second direction (the conveying direction in FIG. 4). Further, the shape of the pressure chamber as viewed in the direction orthogonal to the plane in which the pressure chamber is located is not limited to being rectangular, and may be elliptical, circular, etc.

The positional relationship in the first direction (the vertical direction in FIG. 5) between the first channel and the second channel is not particularly limited. For example, the positional relationship in the vertical direction between the first channel 21 and the second channel 22 may be reversed to the positional relationship in the above-described embodiment. In this case, the first channel 21 may be connected to the nozzle 12N, and the second channel 22 may be connected to the other end 12PY of the pressure chamber 12P. Alternatively, for example, the first channel 21 may be located between two second channels 22 in the vertical direction.

The type of the liquid droplet ejecting head in the present disclosure is not limited to the line system, but may also be the serial system.

The object to which the liquid droplet is to be ejected is not limited to the sheet. For example, the object to which the liquid droplet is to be ejected may be cloth, a substrate, or plastic.

The liquid droplet ejected from the nozzle is not limited to the ink droplet. For example, the liquid droplet may be a droplet of a treatment liquid which agglutinates or precipitates a component in an ink.

The present disclosure is not limited to being applicable to printers, and is applicable also to facsimiles, copying machines, and multi-function peripherals. Further, the present disclosure is applicable also to a liquid droplet ejecting apparatus for any usage other than the image recording. For example, the present disclosure is applicable to a liquid droplet ejecting apparatus which ejects a conductive liquid to a substrate so as to form a conductive pattern.

What is claimed is:

1. A liquid droplet ejecting head comprising:
a pressure chamber located along a plane;
a nozzle which is open in a direction crossing the plane;
a connecting channel connecting the pressure chamber and the nozzle, the connecting channel including a first channel extending parallel to the plane and a second channel extending in a first direction crossing the plane, wherein
inertance of the first channel is greater than inertance of the second channel.

2. The liquid droplet ejecting head according to claim 1, wherein
the second channel has one end and the other end in the first direction, and the other end is connected to the nozzle, and
the first channel has one end connected to the one end of the second channel and the other end connected to the pressure chamber.

3. The liquid droplet ejecting head according to claim 2, wherein
the other end of the first channel is connected to the pressure chamber, not via a channel extending in a direction crossing the plane.

4. The liquid droplet ejecting head according to claim 1, wherein
the first channel has a narrowed portion, a channel cross-sectional area of the narrowed portion being smaller than both a channel cross-sectional area of the one end of the first channel and a channel cross-sectional area of the other end of the first channel.

5. The liquid droplet ejecting head according to claim 1, wherein
the inertance of the first channel is equal to or less than inertance of the nozzle.

6. The liquid droplet ejecting head according to claim 1, further comprising plates constructing the connecting channel.

7. The liquid droplet ejecting head according to claim 6, further comprising:
individual channels each of which includes the pressure chamber, the nozzle, and the connecting channel;
a common channel which communicates with the plurality of individual channels;
a third channel included in each of the plurality of individual channels, the third channel extending parallel to the plane and communicating one end of the pressure chamber with the common channel, the one end of the pressure chamber being opposite to the other end, of the pressure chamber, connected to the connecting channel, wherein
both the first channel and the third channel are located in one plate of the plurality of plates.

8. The liquid droplet ejecting head according to claim 7, wherein
the first channel and the third channel are located over entire thickness of the one plate.

9. The liquid droplet ejecting head according to claim 7, wherein
the one end and the other end of the pressure chamber are located at a central portion in a third direction of the pressure chamber, the third direction being along the plane and orthogonal to a second direction passing through the one end and the other end.

10. The liquid droplet ejecting head according to claim 7, wherein
the first channel and the third channel extend in a direction inclined with respect to both a second direction passing through the one end and the other end of the pressure chamber and a third direction which is along the plane and orthogonal to the second direction.

11. The liquid droplet ejecting head according to claim 1, wherein
the inertance of the first channel is 1.20×10⁷ [kg/m⁴] or more.

12. The liquid droplet ejecting head according to claim 1, further comprising:
a channel member having individual channels each of which includes the connecting channel, and a common channel communicating with the plurality of individual channels; and
a piezoelectric element fixed to the channel member, wherein
each of the plurality of individual channels includes:
a pressure chamber located along a plane and having one end and the other end in a second direction which is along the plane;
a communicating channel communicating the one end of the pressure chamber and the common channel and having a third channel which extends parallel to the plane;
the nozzle; and
the connecting channel,
the connecting channel connects the nozzle and the other end of the pressure chamber,
the piezoelectric element is configured to apply pressure to a liquid in the pressure chamber so as to eject a liquid droplet of the liquid from the nozzle, and
the liquid droplet ejecting head is configured to satisfy the following Expressions (1) and (2):
$$M 2 \leq 3.23 \times 1 {0}^{- 1} \times M 1 - 1.95 \times 1 {0}^{7} \qquad Expression ( 1 )$$
$$M 2 \leq - 8.37 \times 1 {0}^{- 1} \times M 1 + 2.2 \times 1 {0}^{8} \qquad Expression ( 2 )$$
wherein M1 is inertance [kg/m⁴] of the third channel, and M2 is inertance [kg/m⁴] of the first channel.

13. The liquid droplet ejecting head according to claim 12, further satisfying the following Expression (3):
$$M 2 \leq - 7.49 \times M 1 + 9.83 \times 1 {0}^{8} \qquad Expression ( 3 )$$

14. The liquid droplet ejecting head according to claim 12, further satisfying the following Expression (4):
$$M 2 \leq M 3 \qquad Expression ( 4 )$$
wherein M3 is inertance [kg/m⁴] of the nozzle.

15. The liquid droplet ejecting head according to claim 12, wherein
the second channel has one end and the other end in the first direction, the other end connecting to the nozzle,
the first channel has one end connecting to the one end of the second channel and the other end connecting to the other end of the pressure chamber,
the other end of the first channel is a hole extending in the first direction crossing the plane, and
a channel cross-sectional area of the hole is smaller than a channel cross-sectional area of the one end of the first channel.

16. The liquid droplet ejecting head according to claim 12, wherein
the second channel has one end and the other end in the first direction, the other end connecting to the nozzle,
the first channel has one end connecting to the one end of the second channel and the other end connecting to the other end of the pressure chamber,
the first channel has a narrowed portion, a channel cross-sectional area of the narrowed portion being smaller than both a channel cross-sectional area of the one end of the first channel and a channel cross-sectional area of the other end of the first channel.

17. The liquid droplet ejecting head according to claim 12, further satisfying the following Expression (5):
$$M 2 \geq 1.2 \times 1 {0}^{7} \qquad Expression ( 5 )$$

18. A liquid droplet ejecting head comprising:
a channel member having individual channels each of which includes a connecting channel, and a common channel communicating with the individual channels; and
a piezoelectric element fixed to the channel member, wherein
each of the plurality of individual channels includes:
a pressure chamber located along a plane and having one end and the other end in a second direction which is along the plane;
a communicating channel communicating the one end of the pressure chamber and the common channel and having a third channel which extends parallel to the plane;
the nozzle; and
the connecting channel,
the connecting channel connects the nozzle and the other end of the pressure chamber,
the piezoelectric element is configured to apply pressure to a liquid in the pressure chamber so as to eject a liquid droplet of the liquid from the nozzle,
a natural frequency of each of the plurality of individual channels is 150 kHz or more, and
the liquid droplet ejecting head satisfying the following Expressions (6) and (7):
$$M 2 \leq 2.67 \times 1 {0}^{- 16} \times M {1}^{3} - 7.84 \times 1 {0}^{- 8} \times M {1}^{2} + 7.83 \times M 1 - 2.31 \times 1 {0}^{8} \qquad Expression ( 6 )$$
$$M 2 \leq - 6.02 \times 1 {0}^{- 10} \times M {1}^{2} + 4.88 \times 1 {0}^{- 1} \times M 1 - 2.66 \times 1 {0}^{7} \qquad Expression ( 7 )$$
wherein M1 is inertance [kg/m⁴] of the third channel, and M2 is inertance [kg/m⁴] of the first channel.

19. The liquid droplet ejecting head according to claim 18, further satisfying the following Expression (8):
$$M 2 \leq M 3 \qquad Expression ( 8 )$$
wherein M3 is inertance [kg/m⁴] of the nozzle.

20. The liquid droplet ejecting head according to claim 18, wherein
the second channel has one end and the other end in the first direction, the other end connecting to the nozzle,
the first channel has one end connecting to the one end of the second channel and the other end connecting to the other end of the pressure chamber,
the other end of the first channel is a hole extending in the first direction crossing the plane, and
a channel cross-sectional area of the hole is smaller than a channel cross-sectional area of the one end of the first channel.

21. The liquid droplet ejecting head according to claim 18, wherein
the second channel has one end and the other end in the first direction, the other end connecting to the nozzle,
the first channel has one end connecting to the one end of the second channel and the other end connecting to the other end of the pressure chamber, and
the first channel has a narrowed portion, a channel cross-sectional area of the narrowed portion being smaller both a channel cross-sectional area of the one end of the first channel and a channel cross-sectional area of the other end of the first channel.

22. The liquid droplet ejecting head according to claim 18, further satisfying the following Expression (9):
$$M 2 \geq 1.2 \times 1 {0}^{7} \qquad Expression ( 9 )$$

23. The liquid droplet ejecting head according to claim 18, further comprising a controller configured to apply a drive signal to the piezoelectric element, wherein
a width of a pulse which is included in the drive signal and by which the liquid droplet is ejected from the nozzle is in a range of 2.0 μsec to 3.5 μsec.

24. The liquid droplet ejecting head according to claim 12, wherein
the channel member is configured such that a ratio of a secondary frequency to a primary frequency of a drive frequency of the piezoelectric element at one end, of the connecting channel, connecting to the nozzle is within a range of 2.0 to 3.2.

25. The liquid ejecting head according to claim 24, wherein
the primary frequency is 150 kHz or more.

26. The liquid ejecting head according to claim 25, wherein
the primary frequency is 200 kHz or less.

27. The liquid ejecting head according to claim 24, wherein
a diameter of the nozzle is 14 μm or more.

28. The liquid ejecting head according to claim 27, wherein
the diameter of the nozzle is 30 μm or less.

29. The liquid ejecting head according to claim 24, wherein
an amplitude of the secondary frequency is 0.5 times or less an amplitude of the primary frequency.

30. The liquid ejecting head according to claim 24, wherein
the connecting channel includes:
a first portion defining the one end of the connecting channel, extending in a direction approaching the pressure chamber from the nozzle and not overlapping with the pressure chamber in the direction; and
a second portion extending from a downstream end in the direction of the first portion toward the pressure chamber and parallel to the plane in which the pressure chamber is located, a channel width of the second portion being smaller than a channel width of the first portion.
